(19) United States
(12) Patent Application Publication
(10) Pub. No.: US 2009/0064827 A1
(43) Pub. Date: Mar. 12, 2009

(54) QUICK DETACHING COMBINING ROD

(76) Inventor: Chang-Ying Chen, Taichung City (TW)

Correspondence Address: Chien-Hui Su, P. O. Box 70-121 Taichung, Taichung City, 40899, TW

(21) Appl. No.: 11/852,332

(22) Filed: Sep. 10, 2007

(51) Int. Cl. B25B 21/00

(52) U.S. Cl. 81/438

(57) ABSTRACT

A quick detaching combining rod comprises: a hollow sleeve; a hollow rod body received in the sleeve; the rod body having a hollow inner space for receiving an engaging block and a first spring; a wall of the rod body being formed with two penetrating holes; the rod body receiving an opener head and a combining rod; the buckling groove having a protrusion which adheres to an outer wall of the rod body; the engaging block being received in the hollow inner space of the rod body and being between the opener head and the combining rod; an upper end of the combining rod being inserted into the combining space of the rod body and compressing a lower end of the first spring; a lower end of the combining rod being formed with a combining end for combining with a handle or a driving tool.

### FIELD OF THE INVENTION

The present invention relates to quick detaching combining rods, and particularly to a quick detaching combining rod which has a simple structure and an opener head can be inserted thereto affectively.

### BACKGROUND OF THE INVENTION

Referring to FIGS. 1A to 1C, a prior art quick detaching combining rod is illustrated. The quick detaching combining rod has a sleeve 10 and a rod body 20. An interior of the sleeve 10 has an engaging block 30 and a spring 40. The sleeve 10 encloses the rod body 20. A buckle 21 is installed between the sleeve 10 and the rod body 20. The engaging block 30 includes a stopper 31 and a limiting block 32. In normal state, by the function of the buckle 21 (referring to FIG. 1A), the engaging block 30 is limited. The engaging block 30 will prevent that another end of the buckle 21 interacts with the engaging block 30. If the quick detaching combining rod suffers from an external force or is affected by an external force, the engaging block 30 displaces. At the same time, the buckle 21 moves toward an interior of the rod body 20 (referring to FIG. 1B). When the lower side of the engaging block 30 is ejected by the spring 40, a front end of the stopper 31 or the engaging block 30 is driven by the buckle 21 (referring to FIG. 1C) so that it cannot return to the normal position. As a result, the opener head cannot be inserted into the rod body and thus the quick detaching combining rod lost the function of receiving an opener head. Thus the quick detaching combining rod makes troubles to users.

### SUMMARY OF THE INVENTION

Accordingly, the primary object of the present invention is to provide a quick detaching combining rod which has a simple structure and an opener head can be inserted thereto affectively.

To achieve above objects, the present invention provides a quick detaching combining rod comprising: a hollow sleeve; a hollow rod body received in the sleeve; the rod body having a hollow inner space for receiving an engaging block and a first spring; a wall of the rod body being formed with two holes which penetrates the wall of the rod body; a periphery of the rod body being formed with an annular buckling groove for receiving a C ring; a second spring and a retaining ring enclosing a lower side of the rod body; a lower end of the rod body being formed with a combining space and an upper end of the rod body being formed with an engaging space; the engaging space serving to receive an opener head and the combining space serving to receive a combining rod; the buckling groove having a protrusion which adheres to an outer wall of the rod body; two ends of the buckling groove being formed with a first end and a second end; the first end being shorter than the second end; the engaging block being received in the hollow inner space of the rod body and being between the opener head and the combining rod; one end of the engaging block being formed with an enlarged resisting end and another end thereof being formed with a limiting block; an upper end of the resisting end being protruded with a stopper; an upper end of the combining rod being inserted into the combining space of the rod body and compressing a lower end of the first spring; a lower end of the combining rod being formed with a combining end for combining with a handle or a driving tool; the opener head having an annular recess, a guide end and a driving head; the guide end and the stopper being used to guide and position the opener head to a correct position. In assembly, a part of the rod body is received in the sleeve with an upper end and a lower end of the rod body being protruded from an upper and a lower opening of the sleeve; the buckle, C ring, second spring and retaining ring are received within the sleeve.

The various objects and advantages of the present invention will be more readily understood from the following detailed description when read in conjunction with the appended drawing.

### BRIEF DESCRIPTION OF THE DRAWINGS

FIG. 1A is schematic cross sectional view of a prior art connecting rod which is in a normal state.

FIG. 1B is schematic cross sectional view of a prior art connecting rod which is in a transition state.

FIG. 1C is schematic cross sectional view of a prior art connecting rod which is in an abnormal state.

FIG. 2 is an explosive schematic view of the present invention.

FIG. 2A is a partial enlarged view of the FIG. 2.

FIG. 3 is a schematic view showing the first state of the quick detaching combining rod of the present invention.

FIG. 4 is a schematic view showing the second state of the quick detaching combining rod of the present invention.

FIG. 5 is a schematic cross sectional view showing the first state of the quick detaching combining rod of the present invention.

FIG. 5A is a partial enlarged schematic view of the FIG. 5.

FIG. 6 is a schematic cross sectional view showing the second state of the quick detaching combining rod of the present invention.

FIG. 6A is a partial enlarged schematic view of FIG. 6.

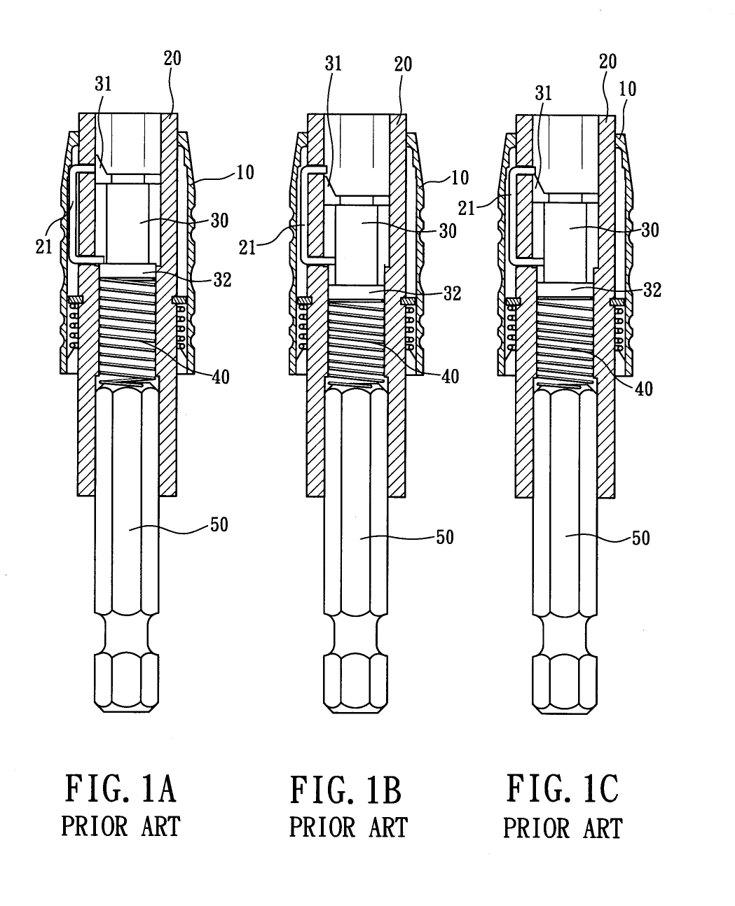

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

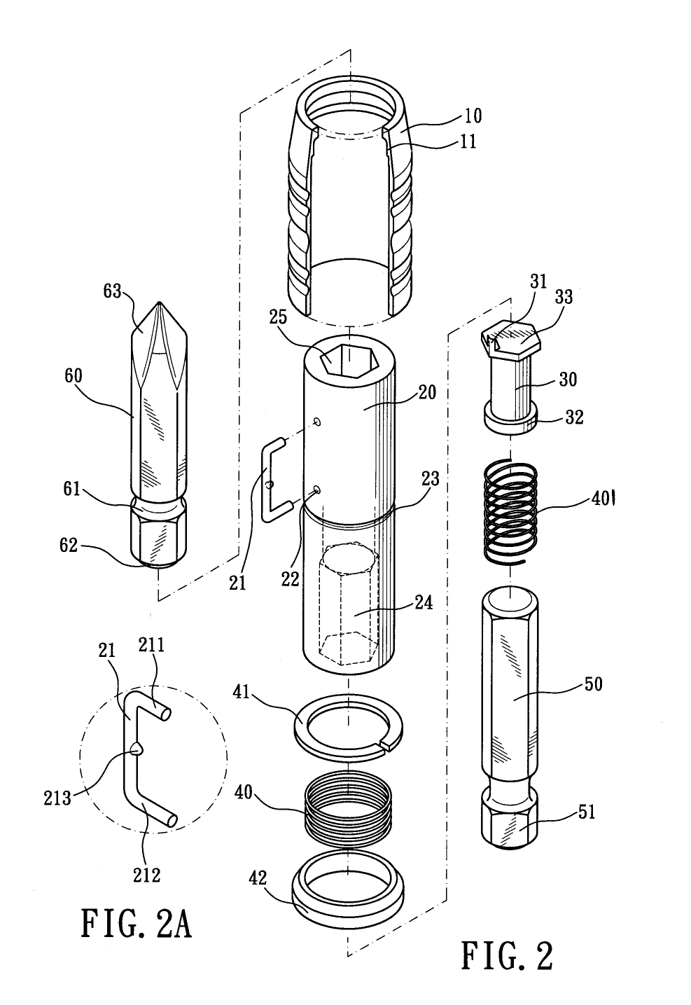

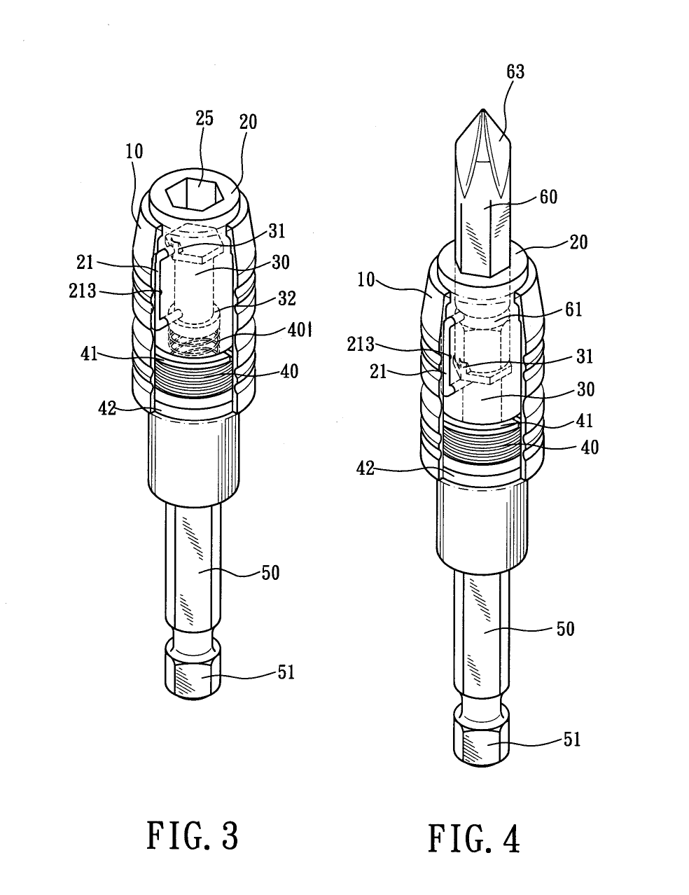

Referring to FIGS. 2 to 4, the structure of the present invention is illustrated. The present invention has the following elements.

A hollow sleeve 10 has a resisting section 11 at an inner upper end thereof.

A hollow rod body 20 can be received in the sleeve 10. The rod body 20 has a hollow inner space for receiving an engaging block 30 and a first spring 401. A wall of the rod body 20 is formed with two holes 22 which penetrates the wall of the rod body 20 for retaining a U shape buckle 21. A periphery of the rod body 20 is formed with an annular buckling groove 23 for receiving a C ring 41. A second spring 40 and a retaining ring 42 enclose a lower side of the rod body 20. A lower end of the rod body 20 is formed with a combining space 24 and an upper end of the rod body 20 is formed with an engaging space 25. The combining space 24 and the engaging space 25 are hexagonal hollow spaces within the rod body 20. The engaging space 25 serves to receive an opener head 60 and the combining space 24 serves to receive a combining rod 50.

The buckling groove 23 has a protrusion 213 which has a round or triangular shape and adheres to an outer wall of the rod body 20. The protrusion 213 may be elastic. Two ends of the buckling groove 23 are formed with a first end 211 and a second end 212. The first end 211 is shorter than the second end 212.

The engaging block 30 is received in the hollow inner space of the rod body 20 and is between the opener head 60 and the combining rod 50. One end of the engaging block 30 is formed with an enlarged resisting end 33 and another end thereof is formed with a limiting block 32. An upper end of the resisting end 33 is protruded with a stopper 31.

An upper end of the combining rod 50 is inserted into the combining space 24 of the rod body 20 and compresses a lower end of the first spring 401. A lower end of the combining rod 50 is formed with a combining end 51 for combining with a handle or a driving tool.

The opener head 60 has an annular recess 61, a guide end 62 and a driving head 63. The guide end 62 and the stopper 31 are used to guide and position the opener head 60 to a correct position. The driving head 63 may be a straight tip end, has a cruciform, a rectangular form or a hexagonal form. It is not confined to a cruciform as illustrated in the drawings.

In assembly, a part of the rod body 20 is received in the sleeve 10 with an upper end and a lower end of the rod body 20 being protruded from an upper and a lower opening of the sleeve 10. The buckle 21, C ring 41, second spring 40 and retaining ring 42 are received within the sleeve 10.

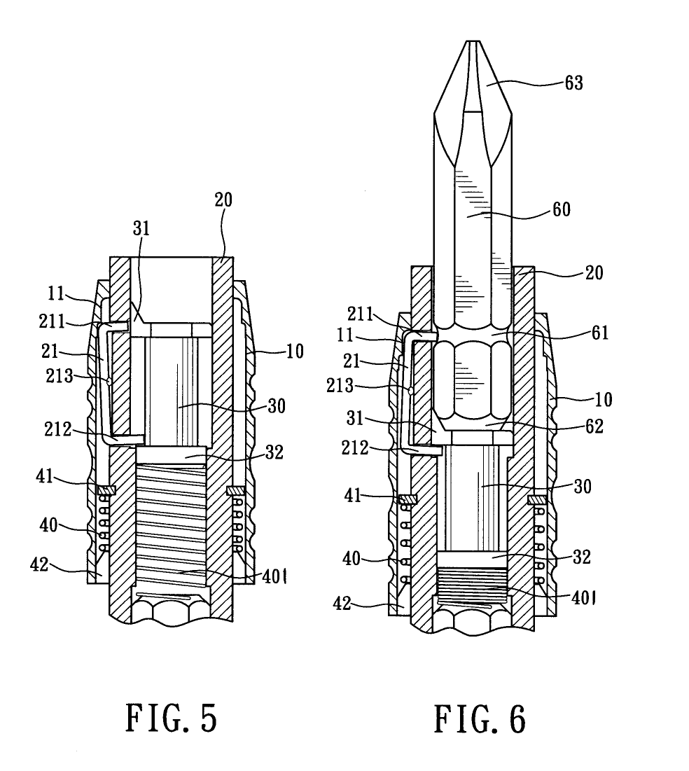

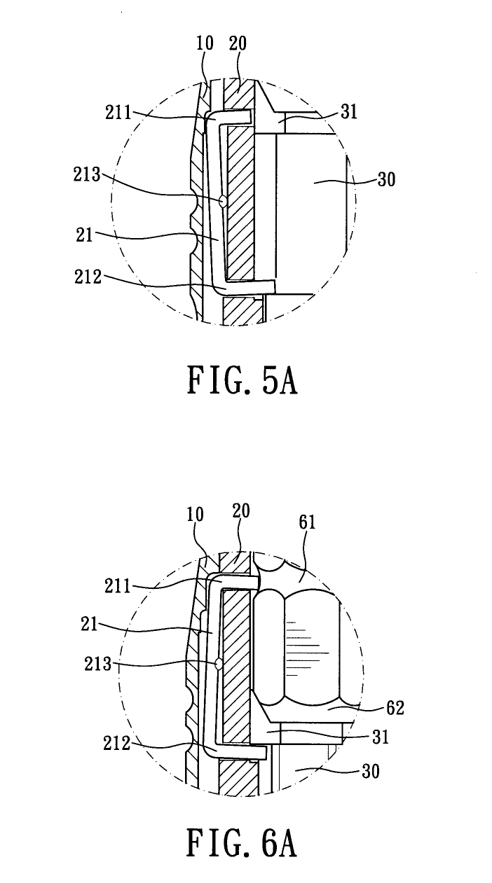

Referring to FIGS. 5A and 5b, the application of the present invention will be described herein. In a first state, the first spring 401 will push the engaging block 30. The second end 212 of the buckle 21 will limit the limiting block 32 of the engaging block 30 so that the engaging block 30 will be ejected to be out of the rod body 20. The buckle 21 is limited by the protrusion 213. The buckle 21 rotates along the fulcrum of the protrusion 213 (if the protrusion 213 is a spring or an elastic sheet, then the buckle 21 will be ejected by elastic forces) so that the first end 211 of the buckle 21 moves outwards along a radial direction of the rod body 20 without moving into the rod body 20 so as to interfere the insertion of the opener head 60. Referring to FIGS. 6A and 6B, in the second state, the opener head 60 is inserted into the engaging space 25, by the action of the stopper 31, the guide end 62 will contact the resisting end 33 to drive the engaging block 30 to move downwards so as to compress the second spring 40. Meanwhile, the resisting section 11 of the sleeve 10 will interact with the rod body 20 to drive the first end 211 of the buckle 21 to move along an axial direction of the rod body 20 and move into the rod body 20. The first end 211 will buckle to the annular recess 61 so as to limit the movement of the opener head 60. Thus the insertion operation of the opener head 60 is complete.

If it is desired to take down the opener head 60, it is only necessary to the push the sleeve 10 so that the resisting section 11 do not interact with the buckle 21. The buckle 21 and the engaging block 30 return to the first state. The opener head 60 will not confine by the buckle 21. The engaging block 30 will be ejected outwards to eject the opener head 60. Then the limiting block 32 is confined by the buckle 21 and thus the opener head 60 is released.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A quick detaching combining rod comprising:
a hollow sleeve;
a hollow rod body received in the sleeve; the rod body having a hollow inner space for receiving an engaging block and a first spring; a wall of the rod body being formed with two holes which penetrates through the wall of the rod body; a periphery of the rod body being formed with an annular buckling groove for receiving a C ring; a second spring and a retaining ring enclosing a lower side of the rod body; a lower end of the rod body being formed with a combining space and an upper end of the rod body being formed with an engaging space; the engaging space serving to receive an opener head and the combining space serving to receive a combining rod;
the buckle having a protrusion which abuts against an outer wall of the rod body; the protrusion being elastic or being an elastic sheet; two ends of the buckle being formed with a first end and a second end; the first end being shorter than the second end;
the engaging block being received in the hollow inner space of the rod body and being between the opener head and the combining rod; one end of the engaging block being formed with an enlarged resisting end and another end thereof being formed with a limiting block; an upper end of the resisting end being protruded with a stopper;
an upper end of the combining rod being inserted into the combining space of the rod body and compressing a lower end of the first spring; a lower end of the combining rod being formed with a combining end for combining with a handle or a driving tool;
the opener head having an annular recess, a guide end and a driving head; the guide end and the stopper being used to guide and position the opener head to a correct position;
wherein in assembly, a part of the rod body is received in the sleeve with an upper end and a lower end of the rod body being protruded from an upper and a lower opening of the sleeve; the buckle, the C ring, the second spring and the retaining ring are received within the sleeve.

2. The quick detaching combining rod as claimed in claim 1, wherein the sleeve has a resisting section at an inner upper end thereof for pushing the buckle.

3. The quick detaching combining rod as claimed in claim 1, wherein the buckle has a U shape and a first end thereof is shorter than the second end.

4. The quick detaching combining rod as claimed in claim 1, wherein the protrusion has a round or triangular shape.

5. (canceled)

6. (canceled)
